(19) United States
(12) Patent Application Publication
(10) Pub. No.: US 2024/0192459 A1
(43) Pub. Date: Jun. 13, 2024

(54) RETAINING DEVICES

(71) Applicant: Telefonaktiebolaget LM Ericsson (PUBL), Stockholm (SE)

(72) Inventors: Claudio D'INCÀ, Genova (IT); Sergio MOSTI, Genova (IT)

(21) Appl. No.: 18/550,374

(22) PCT Filed: Mar. 16, 2021
(86) PCT No.: PCT/EP2021/056740

§ 371 Date: Sep. 13, 2023

(51) Int. Cl. G02B 6/44

(52) U.S. Cl. CPC G02B 6/4471

(57) ABSTRACT

A retaining device for retaining optical fibre cables is provided. The retaining device comprises a body member and a movable member, wherein the body member and movable member are configurable to define a plurality of channels configured to receive optical fibre cables, wherein the channels have a profile configured to restrain a longitudinal movement of the optical fibre cable received within them, wherein the movable member is selectively movable relative to the body member in order to adjust a dimension of the channels.

### TECHNICAL FIELD

The present disclosure relates to retaining devices for retaining fibre optic cables and is particularly, although not exclusively, concerned with a sealing unit, cabinet or mast comprising one or more of the retaining devices.

### BACKGROUND

With reference to FIGS. 1 and 2, a previously proposed cabinet 2, e.g. provided as part of a telecommunications network, may contain one or more optical components 10 within an interior 3 of the cabinet. Connections between components of the telecommunications network, such as the optical components 10, may be made by optical fibre cables extending between the components. Accordingly, the cabinet 2 may be configured to allow optical fibre cables to pass into the cabinet to reach the optical components 10.

As depicted, the cabinet 2 may comprise a gasket 20 provided in one wall 4 of the cabinet 2. The gasket 20 comprises a plurality of openings 22 through which the optical fibre cables can be inserted. In this way, the cabinet 2 attempts to maintain a watertight seal in order to reduce or prevent ingress of water or other contaminants into the interior 3 of the cabinet.

The cabinet 2 further comprises two previously proposed retaining devices 30, 40. In particular, the cabinet comprises an interior retaining device 30 provided on an interior side 20a of the gasket 20 and an exterior retaining device 40 provided on an exterior side 20b of the gasket 20, relative to the interior 3 of the cabinet. The retaining devices 30, 40 comprise a plurality of channels 32, 42 which are to receive the optical fibre cables in order to hold the optical fibre cables generally in alignment with the openings 22 in the gasket 20. The previously proposed retaining devices may thereby improve the performance of the watertight seal formed by the gasket around the optical fibre cables.

The previously proposed retaining devices 30, 40 are further configured to restrict movements of the optical fibre cables in longitudinal directions of the optical fibres, e.g. to prevent the optical fibre cables being pushed into or pulled out of the cabinet 2. In particular, the channels 32, 42 of the previously proposed retaining devices have profiles comprising one or more protruding portions configured to engage the optical fibre cable in order to restrict the movements of the optical fibre cables in the longitudinal direction.

### SUMMARY

According to an aspect of the present disclosure, there is provided a retaining device for retaining optical fibre cables. The retaining device comprises a body member and a movable member. The body member and movable member are configurable to define a plurality of channels configured to receive optical fibre cables. The channels have a profile configured to restrain a longitudinal movement of the optical fibre cable received within them. The movable member is selectively movable relative to the body member in order to adjust a dimension of the channels.

The movable member may be movable relative to the body member between a first position, at which the dimension of the channels is at a maximum, and a second position at which the dimension of the channels is at a minimum.

The body member may comprise a plurality of projections extending parallel to and spaced apart from one another. The channels may be formed between adjacent pairs of the projections.

The movable member may comprise a plurality of projections extending parallel to and spaced apart from one another. The channels may be formed between adjacent pairs of the projections.

When the movable member is in the second position, there may be a greater offset between the projections of the movable member and the projections of the body member in the direction perpendicular to the longitudinal direction of the channels than when the movable member is in the first position.

The movable member may be slidably coupled to the body member, such that the movable member is slidable relative to the body member in the direction perpendicular to the longitudinal direction of the channels between the first and second positions.

The body member may comprise a space extending in the direction perpendicular to the longitudinal direction of the channels. The movable member may be received within the space.

The retaining device may further comprise an adjustment member. The adjustment member may comprise one or more cam surface portions configured to engage an engaging surface of the movable member. The adjustment member may be movable relative to the body member in order to move the movable member relative to the body member.

The one or more cam surface portions may comprise a first surface portion and a second surface portion. The retaining device may be configured such that when the engaging surface of the movable member engages the first surface portion the movable member is in the first position and when the complementary surface of the movable member engages the second surface portion the movable member is in the second position.

The first and second surface portions may be flat surface portions. The first and second surface portions may be to engage a flat surface portion of the engaging surface when the movable member is in the first and second positions respectively.

The first and second surface portions may be arranged on opposing sides of the adjustment member from one another. The adjustment member is pivotally coupled to, e.g. attached in, the body member. The cam surface portions of the adjustment member may extend about a pivot axis of the adjustment member such that a position on the cam surface portions at which the engagement surface movable member engages the cam surface portions varies based on a pivot angle of the adjustment member relative to the body member. A distance between the cam surface portions and a pivot axis of the adjustment member may be greater between the first and second surface portions than at the first and second surface portions.

The adjustment member may comprise a shoulder. The shoulder may comprise an abutment surface configured to abut the movable member in order to restrict movement of the adjustment member relative to the movable member in a direction perpendicular to the abutment surface. For example, the abutment surface may be perpendicular to the pivot axis of the adjustment member.

The adjustment member may comprise one or more curved surface portions arranged between or adjacent to the one or more cam surface portions. The curved surface portions may be to support rotation of the adjustment member relative to the body member.

The retaining device may comprise a resilient element arranged to bias the movable member towards the adjustment member.

According to another aspect of the disclosure, there is provided a sealing unit for a cabinet containing optical components. The sealing unit comprises a gasket defining a plurality of apertures configured to provide a seal around a plurality of optical fibre cables, wherein the gasket has an interior side intended to face the interior of the cabinet and an exterior side intended to face an exterior of the cabinet. The sealing unit further comprises a retaining device which is located on the interior or exterior side of the gasket. The retaining device comprises a plurality of channels, wherein the channels are aligned with respective apertures of the gasket and the channels are configured to receive one of the plurality of optical fibre cables. The retaining device comprises a body member and a movable member, wherein the body member and movable member are configurable to define the plurality of channels. The channels have a profile configured to restrain a longitudinal movement of the optical fibre cable received within them. The movable member is selectively movable relative to the body member in order to adjust a dimension of the channels. The retaining device may be arranged immediately adjacent to the gasket.

According to another aspect of the present disclosure, there is provided a cabinet or mast containing optical components. The cabinet or mast may comprise the above-mentioned retaining device or the above-mentioned sealing unit. The cabinet or mast may comprise a base section and a lid section that are movable relative to each other between an open position and a closed position.

According to another aspect of the present disclosure, there is provided a method of sealing a cabinet or mast containing optical components. The method comprises: providing a sealing unit comprising: a gasket defining a plurality of apertures configured to provide a seal around a plurality of optical fibre cables, wherein the gasket has an interior side intended to face the interior of the cabinet and an exterior side intended to face an exterior of the cabinet; and a retaining device which is located on the interior side or the exterior side of the gasket, wherein the retaining device comprises a plurality of channels, wherein the channels are aligned with respective apertures of the gasket and the channels are configured to receive one of the plurality of optical fibre cables, wherein the retaining device comprises a body member and a movable member, wherein the body member and movable member are configurable to define the plurality of channels, wherein the channels have a profile configured to restrain a longitudinal movement of the optical fibre cable received within them, wherein the movable member is selectively movable relative to the body member in order to adjust a dimension of the channels. The method further comprises adjusting the position of the movable member of the retaining device based on a dimension of the optical fibre cables to be received within the channels.

The method may further comprise installing the optical fibres within the channels such that the profiles of the channels engage the optical fibres cables to retain the optical fibre cables in the longitudinal direction of the optical fibre cables.

To avoid unnecessary duplication of effort and repetition of text in the specification, certain features are described in relation to only one or several aspects or embodiments of the invention. However, it is to be understood that, where it is technically possible, features described in relation to any aspect or embodiment of the invention may also be used with any other aspect or embodiment of the invention.

### BRIEF DESCRIPTION OF THE DRAWINGS

For a better understanding of the present invention, and to show more clearly how it may be carried into effect, reference will now be made, by way of example, to the accompanying drawings, in which:

FIG. 1 is a perspective view of a previously proposed cabinet containing optical components;

FIG. 2 is a perspective detail view of a previously proposed retaining device for the cabinet shown in FIG. 1;

FIG. 3 is a perspective view of a cabinet containing optical components according to the present disclosure;

FIG. 4 is a perspective detail view of a retaining device provided as part of the cabinet shown in FIG. 3;

FIG. 5 is a perspective view of a retaining device according to the present disclosure;

FIG. 6 is a front cross-sectional view of the retaining device, taken in plane P₁ illustrated in FIG. 5;

FIG. 7a is a top detail view of channels formed by the retaining device shown in FIG. 5, in a first configuration;

FIG. 7b is a top detail view of channels formed by the retaining device shown in FIG. 5, in a second configuration;

FIG. 8 is a top cross-sectional view of the retaining device taken in plane P₂ illustrated in FIG. 5;

FIG. 9 is a front, cross-sectional detail view of an adjustment member for the retaining device taken along line A-A shown in FIG. 8;

FIG. 10 is a perspective view of a cabinet containing optical components according to the present disclosure;

FIG. 11 is a flow chart illustrating a method of sealing a cabinet containing optical components according to the present disclosure; and

FIG. 12 is a flow chart illustrating another method of sealing a cabinet containing optical components according to the present disclosure.

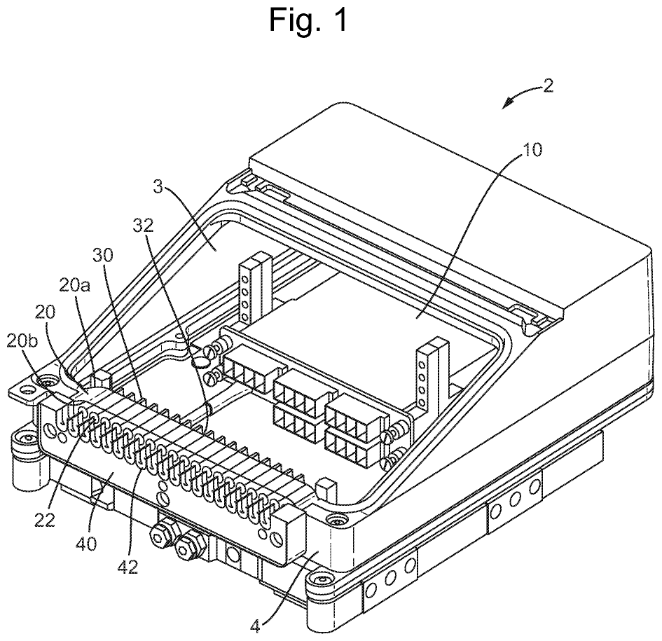

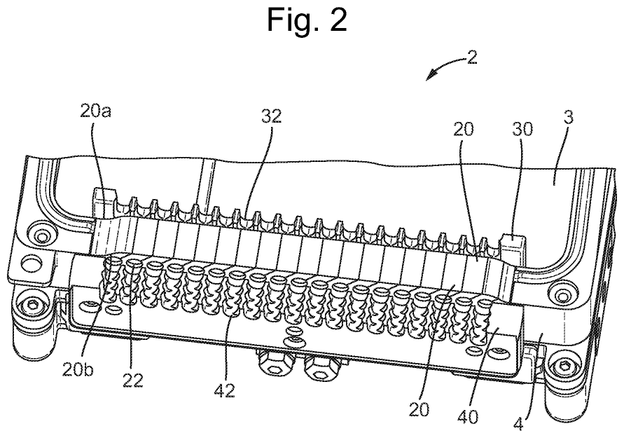

### DETAILED DESCRIPTION

As described above, the retaining devices 30, 40 of the previously proposed cabinet 2 may be configured to appropriately align the optical fibre cables with the openings 22 in the gasket 20 and retain the optical fibre cables in the longitudinal direction of the optical fibre cables.

The optical fibre cables typically comprise a resiliently deformable outer layer. Hence, by appropriately configuring the protruding portions of the profiles of the channels 32, 42 based on the diameter of the optical fibre cables, a level of engagement between the profiles of the channels 32, 42 and the optical fibre cables received within the channels can be achieved that enables a suitable retaining force to be applied to the optical fibre cables without detrimentally affecting ease of installation of the optical fibre cables, or risking damage to the cables due to the engagement.

However, optical fibre cables may be provided in a variety of different diameters, e.g. depending on a manufacturer or specification of the optical fibre cable. It may therefore be desirable to provide a cabinet 100 for containing optical components that is able to receive optical fibre cables having a range of diameters, e.g. depending on a particular installation the cabinet 100 forms part of, the cabinet 100 is able to apply a suitable retaining force to the optical fibre cables having a particular diameter within the range. It is further desirable that these advantages are provided without compromising the ease of installation of the optical fibre cables to the cabinet 100, or risking damage to the optical fibre cables.

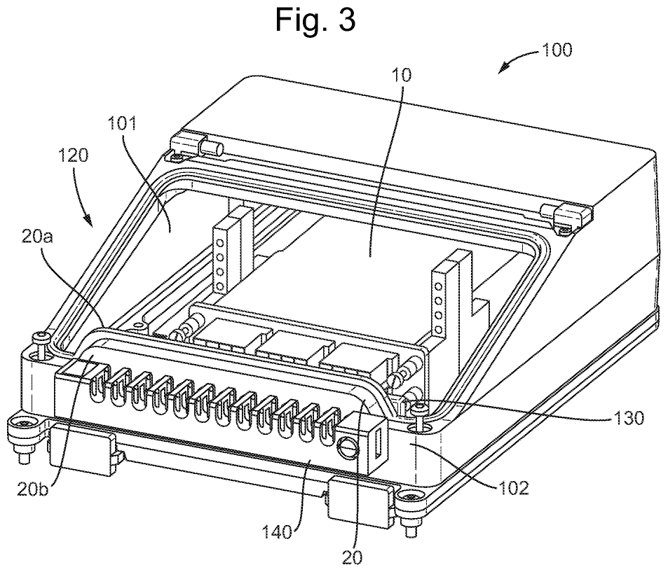

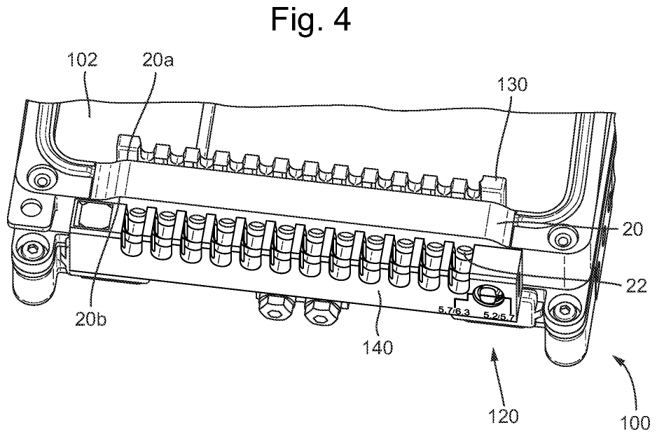

With reference to FIGS. 3 and 4, a cabinet 100 according to the present disclosure will now be described. The cabinet 100 may be for containing optical components 10 within an interior 101 of the cabinet. In FIGS. 3 and 4, the cabinet 100 is shown in isolation. However, it will be appreciated that the cabinet may be coupled to or formed internally with a pole or telecommunications mast, e.g. supporting other telecommunications equipment, such as antennae.

The cabinet 100 comprises a sealing unit 120, e.g. for sealing the cabinet 100 to discourage the ingress of water or other contaminants into the cabinet 100. The sealing unit 120 comprises the gasket 20 provided in one wall 102 of the cabinet 100. As described above, the gasket 20 defines a plurality of openings 22 through which optical fibre cables can be inserted into the interior 101 of the cabinet. The sizes of the openings 22 and the resiliency/deformability of the gasket 20 may be such that optical fibre cables of any desirable diameter, e.g. within the range of diameters, may be inserted through the openings 22.

The sealing unit 120 comprises at least one of a first and second retaining devices 130, 140. In particular, the sealing unit 120 may comprise an interior retaining device 130, located on an interior side 20a of the gasket 20, and/or an exterior retaining device 140, located on an exterior side 20b of the gasket 20. The first and second retaining devices may be arranged immediately adjacent to the gasket 20 on the interior and exterior sides of the gasket respectively. For example, the first and second retaining devices may be in contact with the interior and exterior sides 20a, 20b of the gasket respectively.

The interior and exterior retaining devices 130, 140 may be similar to the retaining devices 30, 40. In particular, the interior and exterior retaining devices 130, 140 may comprise channels 132, 142 to receive the optical fibre cables in order to hold the optical fibre cables generally in alignment with the openings 22 in the gasket 20. The retaining devices 130, 140 differ from the previously proposed retaining devices 30, 40 in that the retaining devices 130, 140 are configured, individually or in combination, to facilitate the installation of optical fibre cables having a diameter within a range of diameters, e.g. a greater range of diameters than that supported by the retaining devices 30, 40, whilst continuing to appropriately align the optical fibre cables with the openings 22 in the gasket 20 and retain the optical fibre cables in the longitudinal direction of the optical fibre cables. In some arrangements, one or both of the retaining devices 130, 140 may be configured to receive optical fibre cables having a range of diameters greater than 0.5 mm or greater than 1 mm. For example, the retaining devices 130, 140 may be configured to receive optical fibre cables having a diameter of between 5.2 mm and 6.3 mm.

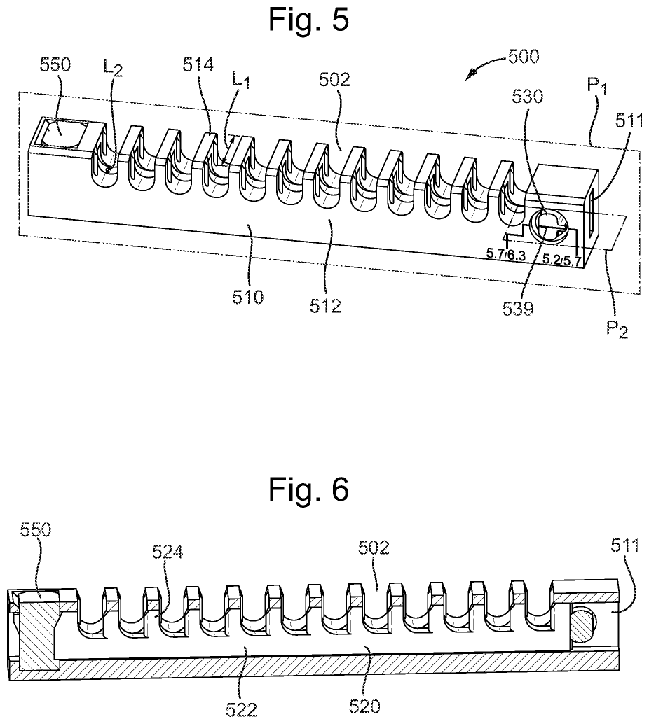

With reference to FIGS. 5 and 6, a retaining device 500 according to arrangements of the present disclosure will now be described. The interior retaining device 130 and/or the exterior retaining device 140 of the cabinet 100 may comprise the retaining device 500.

The retaining device 500 comprises a plurality of channels 502 configured to receive optical fibre cables. Each channel 502 is configured to receive one optical fibre cable.

When the optical fibre cables are received within the channels 502, longitudinal directions of the optical fibre cables are aligned with longitudinal directions of the channels, e.g. with the respective channel in which the particular optical fibre cable is received. The channels 502 have a profile which is configured to restrain a longitudinal movement of the optical fibre cable received within them. In particular, the channels may comprise protruding portions 516, 526, configured to protrude into the space defined by the channel for receiving the optical fibre cable. The protruding portions 516, 526 may be provided on alternating sides of the channels 502 along the longitudinal length of the channels. The protruding portions 516, 526 may engage the optical fibre cables received within the channel in order to restrain the longitudinal movement of the optical fibre.

The retaining device 500 comprises a body member 510 and a movable member 520. The moveable member is configured to be movable relative to the body member 510. In some examples, the movable member is configured to be linearly movable (slide) relative to the body member. The movable member is configured to move in a direction laterally to the longitudinal axis of the channels. As depicted, the body member 510 may comprise a slot 511 extending in a direction perpendicular to the longitudinal direction of the channels, i.e. in a direction laterally to the longitudinal extent of the channel or fibre. The movable member 520 may be received, e.g. linearly moveably (slideably) received, within the slot 511.

The movable member 520 is selectively movable relative to the body member 510, e.g. as described below, in order to adjust a dimension of channels 502 formed by the retaining device 500. The adjustable dimension is in the direction perpendicular to the longitudinal direction of the channels. Thus, the width of the channels is adjustable. Adjusting the dimension of the channels 502 in this way thereby enables optical fibre cables of a range of different diameters to be received in, and longitudinally restrained by, the channels 502. In particular, the configuration of the retaining device to provide a plurality of different channel widths allows a wide range of cables to be securely restrained, i.e. a wider range of cables than could be restrained by a channel having only a single width.

The body member 510 may comprise a plurality of projections 514, e.g. projecting from a base portion 512 of the body member. The projections 514 may extend parallel with one another and may be spaced apart from one another along a length of the body member 510. The channels 502 formed by the retaining device 500 may be located between adjacent pairs of the projections 514. In other words, the projections 514 may form side walls of the channels 502. As shown in FIG. 5, the projections 514 may extend a length L1 in the longitudinal direction of the channels 502.

Returning to FIG. 6, the movable member 520 may similarly comprise a plurality of projections 524, e.g. projecting from a base portion 522 of the movable member. The projections 524 of the movable member 520 may extend parallel with one another and may be spaced apart from one another along a length of the movable member 520. When the movable member 520 is movably coupled to the body member 510, the plurality of projections 524 of the movable member 520 may extend parallel with, e.g. in the same direction as, the plurality of projections 514 of the body member 510 Additionally, the plurality of projections 524 of the movable member may be spaced apart from one another in the same direction and by the same distance as the projections 514 of the body member. As shown in FIGS. 5 and 6, the channels 502 formed by the retaining device 500 may be located between adjacent pairs of the projections 524 of the movable member. The projections 524 may extend a length L2 in the longitudinal direction of the channels 502. In some examples, a profile of the movable member and body member, i.e. projections 514, 524, are substantially the same. As such, when the movable member and body member are aligned in a first position, the projections 514, 524 are coincident or overlap, i.e. in a lateral direction. In this position, the channel widths may be considered as defined by the body member alone, or by both the body member and movable member (since the projections 514,524 of each are coincident).

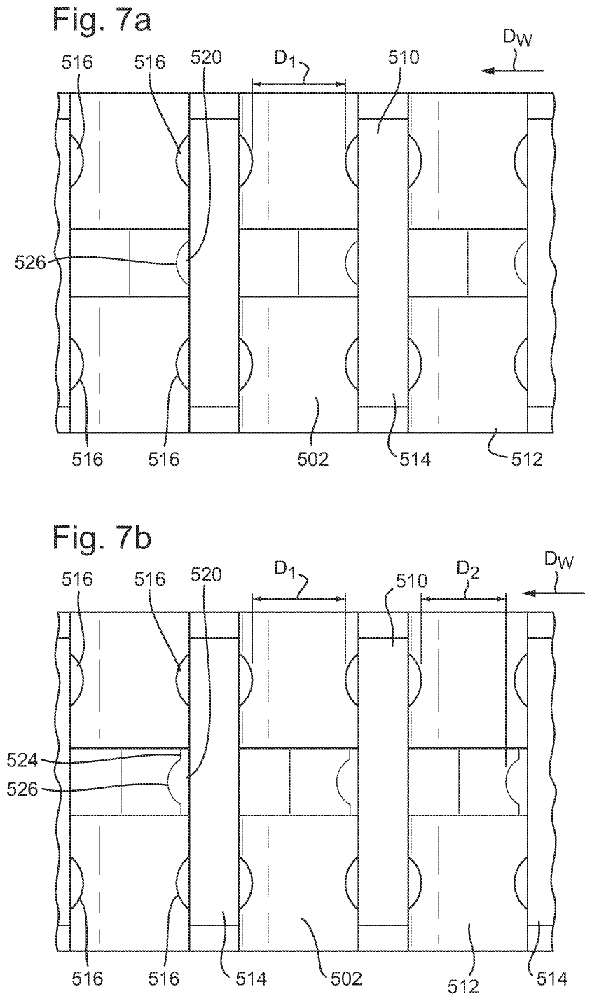

With reference to FIGS. 7a and 7b, the body member 510 and the movable member 520 may comprise protruding portions 516, 526. The protruding portions 516, 526 may be formed on the projections 514, 524 of the body member and movable member and may be arranged to protrude from the side walls of the channels 502 into the spaces defined by the channels for receiving the optical fibre cables. Accordingly, a minimum dimension of the channels 502 in a width direction D_{W} of the channels (perpendicular to the longitudinal direction) may be defined between the protruding portions 516 of the body member 510, and optionally the protruding portions 526 of the movable member 520, or either side of the channel.

In the arrangements shown in FIGS. 7a and 7b, the dimension of the channels, e.g. the minimum dimension of the channels in the width direction D_{W} is defined by the body member 510 and the movable member 520, e.g. the protruding portions 516, 526 on the body member and the movable member. Hence, the optical fibre cable may be held by both, e.g. between, the movable member 520 and the body member 510. In other arrangements, when the movable member 520 is in one or more positions relative to the body member 510, the minimum dimension of the channels in the width dimension D_{W} may be defined by the body member 510 only, e.g. between protruding portions 516 of the body member on either lateral side of the channels 502.

The movable member 520 may be movable, e.g. slideable, relative to the body member 510 between a first position, depicted in FIG. 7a and a second position, depicted in FIG. 7b. When the movable member 520 is in the first position, a dimension, e.g. a minimum dimension, of the channels in the width direction D_{W} is at a maximum D₁; and when the movable member 520 is in the second position, the dimension, e.g. minimum dimension, of the channels in the width direction D_{W} is at a minimum dimension D₂.

As shown in FIGS. 6 and 7a, when the movable member 520 is in the first position, the projection 524 of the movable member 520 may be at least partially aligned with the projections 514 of the body member in the direction perpendicular to the longitudinal direction of the channels (the width direction D_{W}). Additionally, when the movable member 520 is in the first position, the protruding portions 526 formed on the movable member 520 may be substantially aligned with protruding portions 516 formed on the body member 510 in the width direction D_{W} of the channels.

As shown in FIG. 7b, when the movable member 520 is in the second position, there is an offset (or greater offset than in the first position) between the projections 524 of the movable member 520 and the projections 514 of the body member 510. In the second position, the movable member 520 is laterally moved relative to the body member. In the second position, there is a reduced width of the channels 502 compared to the first position. In the second position, the channels 502 have a width defined on one side by the body member (projection 514) and the movable member (projection 524). The width of all the channels is controlled in the same way. This is because the body member and movable member both comprise a plurality of regularly spaced projections 514,524. Hence, linear movement of the movable member in a lateral direction configures the width of all the channels.

In the second position, the protruding portions 526 formed on the movable member 520 may protrude further into the channels 502 than when the movable member is in the first position. When the movable member is in the second position, the protruding portions 526 formed on the movable member 520 may protrude further into the channels 502 than the protruding portions 516 formed on the body member, e.g. on the same side of the channel. The dimension, e.g. minimum dimension, of the channels 502 in the width direction D_{W} is less when the movable member 520 is in the second position compared to when the movable member is in the first position.

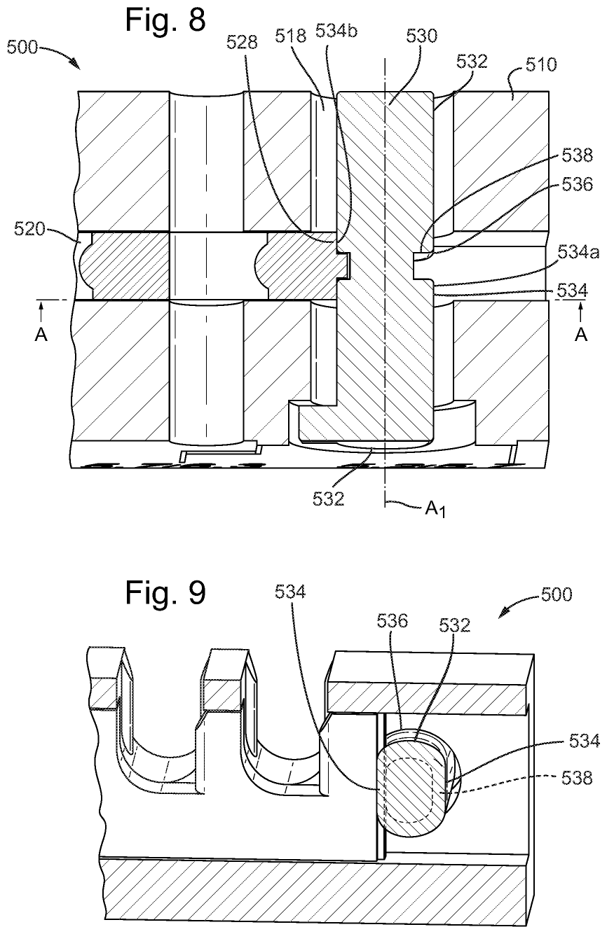

As shown in FIGS. 8 and 9, the retaining device 500 may further comprise an adjustment member 530 for adjusting the position of the movable member 520 relative to the body member 510. The adjustment member 530 is also configured to secure the movable member in the selected position. The adjustment member 530 may be movably, e.g. pivotally or rotatably, attached in the retaining device 500, e.g. coupled to the body member 510. In the arrangement depicted, the body member 510 comprises a bore 518 and the adjustment member 530 is received within the bore 518 so as to be pivotally movable within the bore 518. For example, the adjustment member 530 may comprise one or more curved, e.g. part of a cylinder. The surface portions 532 have a diameter substantially corresponding to the interior diameter of the bore 518. In this way, the adjustment member 530 may be pivotable within the bore 518 about a central axis A₁ of adjustment member, e.g. defined by the surface portions 532. In other words, rotation of the adjustment member 530 relative to the body member 510 may be supported by engagement between the cylindrical surface portions 532 and the bore 518. As depicted, the surface portions 532 may extend partially about the central axis A₁. The surface portions 532 extend around only a part of the perimeter (circumference) of the adjustment member 530. In the example shown, the adjustment member 530 comprises a first and second surface portions 532. The first and second surface portions 532 extend on opposite sides of the adjustment member 530, e.g. top and bottom as shown in FIG. 9. The surface portions 532 extend over a part of the perimeter of the adjustment member 530 to provide for rotation of the adjustment member 530 within the bore 518 around a fixed axis of rotation.

Returning briefly to FIG. 5, the adjustment member 530 may comprise a driver engagement feature 539, such as a slot or opening. The drive engagement feature may be configured to be engaged by a driver, such as a manual or powered screwdriver or key, e.g. hexagonal key. In this way, the driver engagement feature may facilitate actuation, e.g. rotating, of the adjustment member 530 relative to the body member 510.

As shown in FIGS. 8 and 9, the adjustment member 530 may further comprise one or more cam surface portions 534. The cam surface portion 534 may be arranged between or adjacent to the surface portions 532 of the adjustment member about the central axis A₁ and/or along the length of the adjustment member 530. In other arrangements, the cam surface portions may comprise the cylindrical surface portions. In some arrangements, the cam surface portions may extend completely around the central axis A₁. In other arrangements, the cam surface portions may extend partially around the central axis A₁. For example, the cam surface portions and the cylindrical surface portions may together extend completely around the central axis A₁.

The cam surface portions 534 may be configured to engage an engaging surface 528 formed on the movable member 520. The cam surface portions 534 may be disposed about the central axis A₁ of the adjustment member. In the example shown, the cam surface portions 534 are planar. As such, the cam surface portions 534 do not provide for rotation of the adjustment member. A distance from the cam surface portions 534 to the central axis A₁ may vary over the cam surface portions, e.g. around the central axis A₁. Further, the adjustment member 530 may be coupled to the body member 510 such that the central axis A₁ extends in a direction with a component in the longitudinal direction of the channels 502, e.g. perpendicular to the width direction D_{W} shown in FIGS. 7a and 7b. Pivoting the adjustment member 530 relative to the body member 510 may thereby act to urge the movable member 520 in the direction perpendicular to the longitudinal direction of the channels. In other words, the position of the movable member 520 may be adjusted by moving, e.g. pivoting or rotating, the adjustment member 530, by virtue of the engagement between the cam surface portions 534 of the adjustment member and the engaging surface 528 of the movable member 520, in order to adjust the widths of the channels 502.

The cam surface portions 534 of the adjustment member 530 may comprise a first surface portion 534a and a second surface portion 534b. As illustrated, a distance from the first surface portion 534a to the central axis A₁ of the adjustment member may be different from a distance from the second surface portion 534b to the central axis A₁. The distances may refer to the distance when the adjustment member is in the first and second position. For example, one or more distances, e.g. maximum and/or minimum distances, of points on the first surface portion 534a to the central axis A₁ may be less than one or more corresponding distance, e.g. maximum and/or minimum distance, from corresponding points on the second surface portion 534b to the central axis A₁. Accordingly, when the adjustment member 530 is moved such that the engaging surface 528 of the movable member 520 engages a different one of the first and second surface portions 534a, 534b compared to before the adjustment member is moved, a position of the movable member 520 is adjusted relative to the body member 510. For example, the movable member 520 may be moved between the first and second positions. In some arrangements, when the adjustment member 530 is moved relative to the body member 510 so that the complementary surface of the movable member 520 is in contact with the first surface portion 534a, the movable member 520 may be arranged in the first position. When the adjustment member 530 is moved relative to the body member 510 so that the complementary surface of the movable member 520 is in contact with the second surface portion 534b, the movable member 520 may be arranged in the second position. In summary, the first and second surface portions 534a, 534b provide for the movable member 520 to be arranged at different lateral positions relating to the body member 510.

The first and second surface portions 534a, 534b may be flat or planar surface portions. In some examples, the first and second first and second surface portions 534a, 534b are on different sides of the adjustment member, e.g. opposite sides. In some examples, the first and second surface portions 534a, 534b are parallel. The first and second surface portions may be to engage a corresponding flat surface portion of the engaging surface 528 when the movable member is in the first and second positions respectively. In other examples, the first and second surface portions 534a, 534b are curved. The first and second surface portions 534a are positioned such that the movable portion is engaged with engagement member at a different distance from the fixed central axis A₁. This provides for the two different relative positions between the movable member and body member.

A distance between the surface of the adjustment member 520, e.g. the surface portions, and the central axis A₁ of the adjustment member between, e.g. circumferentially between, the first and second surface portions may be greater than a minimum, and optionally a maximum, distance between the first and/or the second surface portions and the central axis. In some arrangements, the distance may be at a maximum between, e.g. circumferentially between, the first and second surface portions 534a, 534b. In other arrangements, the distance between the surface of the adjustment member 520, e.g. the cylindrical surface portions, and the central axis A₁ of the adjustment member between the first and second surface portions may be equal to the maximum distance between the first and/or the second surface portions and the central axis. In still further arrangements, the distance between the surface of the adjustment member 520, e.g. the cylindrical surface portions, and the central axis A₁ of the adjustment member between, e.g. circumferentially between, the first and second surface portions may be less than the minimum distance between the first and/or the second surface portions 534a, 534b and the central axis A₁.

In the arrangements shown in FIGS. 7a and 7b, the adjustment member comprises two surface portions corresponding to first and second positions of the movable member relative to the body member 510. However, in other arrangements the adjustment member 530 may comprise, three, four or more than four surface portions, e.g. flat surface portions, corresponding to positions of the movable member. In alternative arrangements, the surface portions may not be flat, e.g. the surface portions may be curved.

As depicted in FIG. 8, the adjustment member 530 may further comprise a shoulder 536. As depicted, the shoulder 536 may be provided adjacent to the cam surface portions 534. The shoulder 536 comprises an abutment surface 538 configured to abut the movable member 520 in order to restrict movement of the adjustment member 530 relative to the movable member 520 and the body member 510 in a direction perpendicular to the abutment surface, e.g. in a direction parallel with the central axis A₁ of the adjustment member. In this way, engagement between the adjustment member 530 and the movable member 520 may act to retain the adjustment member 530 within the bore 518 of the body member 510. Further, engagement of the adjustment member 530 and the movable member 520 may act to retain the cam surface 534 in alignment with the engaging surface 528 of the movable member. In same arrangements, the adjustment member 530 may comprise a shoulder provided on opposing sides of the cam surface portions along the central axis A₁, in order to restrict movement of the adjustment member 530 in either direction along the central axis A₁.

Returning to FIGS. 5 and 6, the retaining device 500 may further comprise a resilient element 550 arranged to bias the movable member 520 towards, e.g. against, the adjustment member 530, e.g. such that the complementary surface 528 of the movable member engages the cam surface 534 of the adjustment member 530. As depicted, the resilient element 550 may comprise a body of a resilient material received within a space formed in the body member 510.

The use of the rotatable adjustment member provides for a simple mechanism which allows selection of two (or more) positions for the movable member, and hence channel widths. Selection of the alternative channel width is achieved simply by turning of the adjustment member, e.g. with a screwdriver. Once a channel width is selected, the resilient member initially holds the adjustment member in the selected orientation. Insertion of the optical fibre cables additionally urges the movable member against the cam surface portions, further securing the adjustment member in the selected position.

The adjustment member is in a stable position once one of the cam surface portions is engaged with the movable member and a force is applied by the resilient member and/or compression of the optical fibre cables. This is due to both of the cam surface portions having a radius which is less than the surface portions 532.

In other examples, the retaining device comprises a different+mechanism to allow the movable member to movable relative to the body member, such that the width of the channels is configurable. The mechanism provides for the movable member to be secured in place in the first and second position. In this case, secured means that insertion of the cables does not cause the movable member to move in a direction which increases the selected width of the channels. In some examples, the mechanism allows movement between a first position, at which the dimension of the channels is at a maximum, and a second position at which the dimension of the channels is at a minimum. The mechanism has been described as a rotatable adjustment member having two cam surface portions at different positions to the axis of rotation.

The rotation of the adjustment member is described as provided for by the cam surface portions. In other examples, the adjustment member may rotate around or on an axle, or any other suitable mechanism. In other examples, the mechanism provides for the movable member to be secured in place in the first and second position may not use a rotatable adjustment member. The mechanism may be any mechanism which provides for the movable member to be secured in place in the first and second position. For example, the controlled linear sliding of the movable member may be controlled by a ratchet, a movable stop, insertion of pins through aligned holes in the movable member and body member or another mechanism.

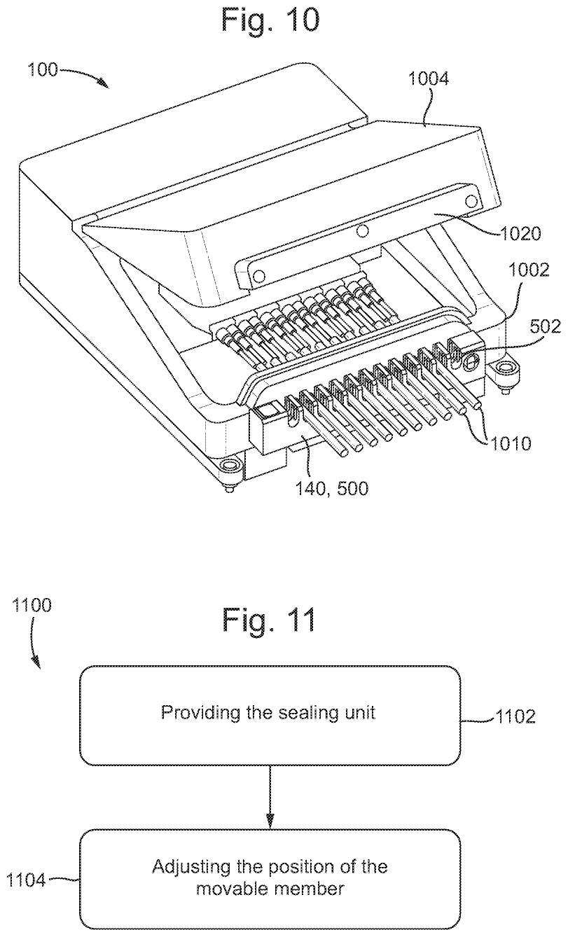

FIG. 10 illustrates the cabinet 100 according to the present disclosure following the installation of optical fibre cables 1010 into the channels 502 formed by the retaining device 500, which is provided as the exterior retaining device 140 of the cabinet 100. As shown in FIG. 10, a further sealing device 1020, may be provided on the exterior side of a lid 1004 of the cabinet. In the arrangement shown in FIG. 10, the lid is pivotable with respect to the cabinet main body 1002 between open and closed positions of the lid.

When the lid of the cabinet is closed, the further sealing device 1020 comes into engagement with the exterior retaining device 140. When the further sealing device 1020 engages the exterior retaining device 140, the further sealing device 1020 may close an open side of the channels 502 defined by the exterior retaining device. In this way, the further sealing device 1020 is configured to co-operate with the exterior retaining device 140 to provide further stability for the optical fibre cables 1010 and/or improve sealing of the cabinet 100.

With reference to FIG. 11, a method of sealing a cabinet containing optical components, such as the cabinet 100, will now be described. The method comprises a first step 1102, at which a sealing unit, such as the sealing unit 120, is provided. In particular, the sealing unit may be provided such that the gasket of the sealing unit is disposed in a wall, such as the wall 102, of the cabinet.

As described above, the sealing unit 120 comprises a retaining device 500 having a body member 510 and a movable member 520 movable relative to the body member in order to adjust width dimensions of channels 502 provided by the retaining device 500 for receiving optical fibre cables.

The method 1100 further comprises a second step 1104, at which the position of the movable member of the retaining device, e.g. forming the first or second retaining device of the sealing unit is adjusted. The position of the movable member may be adjusted based on a dimension of the optical fibre cables to be received within the channels 502. The movable member is moved such that the channels have the narrowest width possible for the diameter of the cables to be installed. Thus, the movable member is adjusted (or kept in position) using the adjustment member to provide small width channels for small diameter cables. For large diameter cables, the movable member is adjusted (or kept in position) using the adjustment member to provide large width channels for large diameter cables. The cables are compressible to some extent, and so each position provides for securely restraining a range of cables. The different positions provide for securely restraining a larger range of cables than possible using a single channel width. In arrangements in which first and second retaining devices of the sealing unit comprise movable members, the position of the movable members of the first and second retaining devices relative to the body members of the respective retaining devices may be adjusted at the second step 1104.

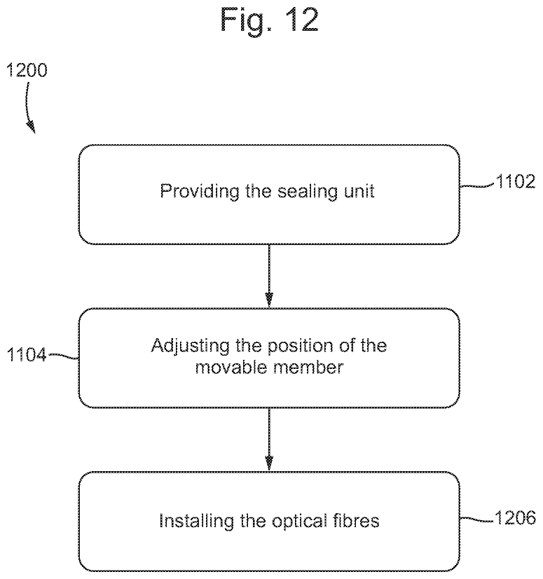

With reference to FIG. 12, a method 1200 of sealing a cabinet containing optical components, such as the cabinet 100, may comprise the method 1200. In particular, the method 1200 may comprise the first and second steps 1102, 1104. The method 1200 may further comprise a third step 1206, in which the optical fibre cables are installed within the channels 502 of the first and/or second retaining devices, such that the profiles of the channels 502 engage the optical fibres cables to retain the optical fibre cables in the longitudinal direction of the optical fibre cables.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

It will be appreciated by those skilled in the art that although the invention has been described by way of example, with reference to one or more exemplary examples, it is not limited to the disclosed examples and that alternative examples could be constructed without departing from the scope of the invention as defined by the appended claims.

1. A retaining device for retaining optical fiber cables, the retaining device comprising a body member and a movable member, wherein the body member and movable member are configurable to define a plurality of channels configured to receive optical fiber cables, wherein the channels have a profile configured to restrain a longitudinal movement of the optical fiber cable received within them, wherein the movable member is selectively movable relative to the body member in order to adjust a dimension of the channels.

2. The retaining device of claim 1, wherein the movable member is movable relative to the body member between a first position, at which the dimension of the channels is at a maximum, and a second position at which the dimension of the channels is at a minimum.

3. The retaining device of claim 1, wherein the body member comprises a plurality of projections extending parallel to and spaced apart from one another, wherein the channels are formed between adjacent pairs of the projections.

4. The retaining device of claim 1, wherein the movable member comprises a plurality of projections extending parallel to and spaced apart from one another, wherein the channels are formed between adjacent pairs of the projections.

5. The retaining device of claim 2, wherein:
when the movable member is in the second position, there is a greater offset between the projections of the movable member and the projections of the body member in the direction perpendicular to the longitudinal direction of the channels than when the movable member is in the first position.

6. The retaining device of claim 1, wherein the body member comprises a space extending in the direction perpendicular to the longitudinal direction of the channels, and wherein the movable member is received within the space.

7. The retaining device of claim 1 further comprising an adjustment member, wherein the adjustment member comprises one or more cam surface portions configured to engage an engaging surface of the movable member, wherein the adjustment member is movable relative to the body member in order to move the movable member relative to the body member.

8. The retaining device of claim 7, wherein the one or more cam surface portions comprise a first surface portion and a second surface portion, wherein the retaining device is configured such that when the engaging surface of the movable member engages the first surface portion the movable member is in the first position and when the complementary surface of the movable member engages the second surface portion the movable member is in the second position.

9. The retaining device of claim 8, wherein the first and second surface portions are arranged on opposing sides of the adjustment member.

10. The retaining device of claim 8, wherein the adjustment member is pivotally attached in the body member, wherein the cam surface portions of the adjustment member extend about a pivot axis of the adjustment member such that a position on the cam surface portions at which the engagement surface movable member engages the cam surface portions varies based on a pivot angle of the adjustment member relative to the body member, and wherein a distance between the cam surface portions and a pivot axis of the adjustment member is greater between the first and second surface portions than at the first and second surface portions.

11. The retaining device of claim 7, wherein the adjustment member comprises a shoulder, the shoulder comprising an abutment surface configured to abut the movable member in order to restrict movement of the adjustment member relative to the movable member in a direction perpendicular to the abutment surface.

12. The retaining device of claim 7, wherein the adjustment member comprises one or more curved surface portions arranged between or adjacent to the one or more cam surface portions, wherein the curved surface portions are to support rotation of the adjustment member relative to the body member.

13. The retaining device of claim 7, wherein the retaining device comprises a resilient element arranged to bias the movable member towards the adjustment member.

14. A sealing unit for a cabinet containing optical components, the sealing unit comprising:
a gasket defining a plurality of apertures configured to provide a seal around a plurality of optical fiber cables, wherein the gasket has an interior side intended to face the interior of the cabinet and an exterior side intended to face an exterior of the cabinet;
a retaining device which is located on the interior or exterior side of the gasket, wherein the retaining device comprises a plurality of channels, wherein the channels are aligned with respective apertures of the gasket and the channels are configured to receive one of the plurality of optical fiber cables, wherein the retaining device comprises a body member and a movable member, wherein the body member and movable member are configurable to define the plurality of channels, wherein the channels have a profile configured to restrain a longitudinal movement of the optical fiber cable received within them, wherein the movable member is selectively movable relative to the body member in order to adjust a dimension of the channels.

15. The sealing unit of claim 14, wherein the retaining device is arranged immediately adjacent to gasket.

16. A cabinet or mast containing optical components, the cabinet or mast comprising the retaining device according to claim 1,
wherein the cabinet or mast comprises a base section and a lid section that are movable relative to each other between an open position and a closed position.

17. A method of sealing a cabinet or mast containing optical components, the method comprising:
providing a sealing unit comprising:
a gasket defining a plurality of apertures configured to provide a seal around a plurality of optical fiber cables, wherein the gasket has an interior side intended to face the interior of the cabinet and an exterior side intended to face an exterior of the cabinet; and
a retaining device which is located on the interior side or the exterior side of the gasket, wherein the retaining device comprises a plurality of channels, wherein the channels are aligned with respective apertures of the gasket and the channels are configured to receive one of the plurality of optical fiber cables, wherein the retaining device comprises a body member and a movable member, wherein the body member and movable member are configurable to define the plurality of channels, wherein the channels have a profile configured to restrain a longitudinal movement of the optical fiber cable received within them, wherein the movable member is selectively movable relative to the body member in order to adjust a dimension of the channels; and
adjusting the position of the movable member of the retaining device based on a dimension of the optical fiber cables to be received within the channels.

18. The method of claim 17, wherein the method further comprises:
installing the optical fibers within the channels such that the profiles of the channels engage the optical fibers cables to retain the optical fibre cables in the longitudinal direction of the optical fiber cables.

19. A cabinet or mast containing optical components, the cabinet or mast comprising the retaining device according to claim 14,
wherein the cabinet or mast comprises a base section and a lid section that are movable relative to each other between an open position and a closed position.
